(19) United States
(12) Patent Application Publication
(10) Pub. No.: US 2026/0056838 A1
(43) Pub. Date: Feb. 26, 2026

(54) DECODERS, DECODING METHODS, MEMORY SYSTEMS, AND MEMORY CONTROLLERS

(71) Applicant: Yangtze Memory Technologies Co., Ltd., Wuhan (CN)

(72) Inventor: Zhiwei Zhuang, Wuhan (CN)

(21) Appl. No.: 19/039,616

(22) Filed: Jan. 28, 2025

(30) Foreign Application Priority Data
Aug. 26, 2024 (CN) 202411179794.2

(51) Int. Cl. G06F 11/10

(52) U.S. Cl. CPC G06F 11/1068; G06F 11/1012; G06F 11/1048

(57) ABSTRACT

Examples of the present disclosure disclose a decoder, a decoding method, a memory system, a memory controller, and a computer readable storage medium. The decoder includes a data processing circuit and a data output circuit. The data processing circuit is configured to: perform a current check computation using a current column of a check matrix and a current submatrix of a current flag matrix, wherein the check matrix includes n columns, n being an integer greater than 1; the current flag matrix includes n submatrices, and the current submatrix is related to a current data block of a flipped code word.

### CROSS-REFERENCE TO RELATED APPLICATIONS

This application claims priority to and the benefit of Chinese Patent Application 202411179794.2, filed on Aug. 26, 2024, which is hereby incorporated by reference in its entirety.

### TECHNICAL FIELD

Examples of the present disclosure relate to the field of memories, and relate to, but are not limited to, decoders, decoding methods, memory systems, and memory controllers.

### BACKGROUND

A memory controller and one or more memories can be integrated into various types of memory devices, such as a Solid State Disk (SSD), a Universal Flash Storage (UFS), and an embedded Multi-Media Card (eMMC), etc. The bit error rate of the memory device increases as memory integration and bit density increase, and data reliability issues become increasingly significant.

In order to improve the data reliability, the Error Correcting Code (ECC) technology has been used to detect and correct errors in data transmission. ECC typically uses a BCH algorithm and a Low Density Parity Check (LDPC) algorithm to encode and decode data, wherein the LDPC algorithm has better error correction capability than the BCH algorithm.

### BRIEF DESCRIPTION OF THE DRAWINGS

In the drawings, unless otherwise specified, the same numeral throughout a plurality of drawings denote identical or similar components or elements. These drawings are not necessarily drawn to scale. It is to be understood that these drawings merely describe some examples disclosed according to the present application, and should not be construed as limiting the scope of the present application.

FIG. 1 is a schematic diagram illustrating an electronic device according to examples of the present disclosure.

FIG. 2A is a schematic diagram illustrating a memory card according to examples of the present disclosure.

FIG. 2B is a schematic diagram illustrating a solid state drive according to examples of the present disclosure.

FIG. 3 is a schematic block diagram illustrating a three-dimensional NAND memory according to examples of the present disclosure.

FIG. 4 is a schematic cross-sectional view illustrating a memory according to examples of the present disclosure.

FIG. 5 is a schematic diagram illustrating a memory comprising a memory cell array and a peripheral circuit according to examples of the present disclosure.

FIG. 6 is a schematic flow diagram illustrating LDPC iterative decoding according to examples of the present disclosure.

FIG. 7 is a schematic block diagram illustrating a decoder according to examples of the present disclosure.

FIG. 8 is a schematic flow diagram illustrating decoding according to examples of the present disclosure.

FIG. 9 is a schematic block diagram illustrating another decoder according to examples of the present disclosure.

FIG. 10 is a schematic flow diagram illustrating another LDPC iterative decoding according to examples of the present disclosure.

FIG. 11 is a schematic diagram illustrating computation of an initial syndrome according to examples of the present disclosure.

FIG. 12 is a schematic diagram illustrating computation of an incremental syndrome according to examples of the present disclosure.

FIG. 13 is a flow diagram illustrating a decoding method according to examples of the present disclosure.

FIG. 14 is a schematic block diagram illustrating a memory system according to examples of the present disclosure.

### DETAILED DESCRIPTION

For ease of understanding the present disclosure, examples of the present disclosure will be described in more detail below with reference to the related accompanying drawings. Although examples of the present disclosure are shown in the drawings, it should be understood that the present disclosure may be implemented in various ways and should not be limited to the DETAILED DESCRIPTION set forth herein. Rather, these examples are provided so that the present disclosure can be more thoroughly understood and the scope of the present disclosure can be fully conveyed to those skilled in the art.

In the following description, numerous specific details are given in order to provide a more thorough understanding of the present disclosure. It will be apparent, however, to one skilled in the art that the present disclosure may be practiced without one or more of these details. In some examples, some technical features well-known in the art are not described to avoid confusion with the present disclosure; that is, all features of the actual example can be not described here, and well-known functions and structures are not described in detail.

In general, terminologies may be understood at least in part from usage in the context. For example, the term “one or more” as used herein, depending at least in part upon the context, can be used to describe any feature, structure, or characteristic in singular sense or can be used to describe combinations of features, structures, or characteristics in plural sense. Similarly, terms, such as “a/an” or “the”, likewise can be understood as conveying singular use or plural use, depending at least in part upon the context. In addition, the term “based on” may be understood as being not necessarily intended to convey an exclusive set of factors and may, instead, allow for existence of additional factors not necessarily described expressly, likewise depending at least in part upon the context.

Unless otherwise defined, the terminology used herein is for the purpose of describing particular examples only and is not to be taken as a limitation of the present disclosure. As used herein, “a”, “an” and “said/the” in singular forms are intended to include the plural forms as well, unless the context clearly dictates otherwise. It should also be understood that at least one of the terms “consists of” or “comprising”, when used in this specification, identify the presence of at least one of stated features, integers, operations, elements or components, but do not exclude presence or addition of at least one of one or more other features, integers, operations, elements, components or groups. As used herein, the term “at least one of ...” includes any and all combinations of the associated listed items.

In order to understand the present disclosure thoroughly, detailed operations and detailed structures will be proposed in the following description to set forth the technical solution of the present disclosure. Detailed descriptions of examples of the present disclosure are as follows. However, the present disclosure may also have other examples in addition to these detailed descriptions.

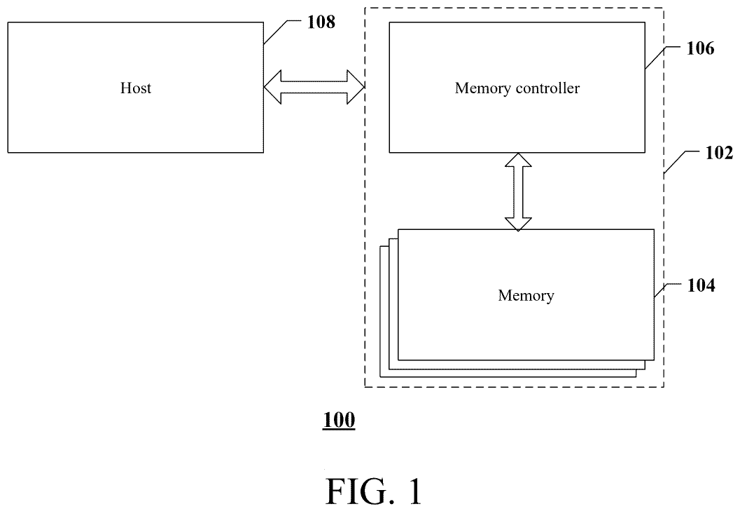

FIG. 1 is a schematic diagram illustrating an electronic device according to examples of the present disclosure. The electronic device 100 can comprise a mobile phone, a desktop computer, a laptop computer, a tablet, a vehicle computer, a gaming console, a printer, a positioning device, a wearable electronic device, a smart sensor, a virtual reality (VR) device, an argumented reality (AR) device, or any other suitable electronic devices having memory devices therein. With reference to FIG. 1, the electronic device 100 can include a host 108 and a memory system 102 having one or more memories 104 and a memory controller 106. The host 108 can comprise a processor of an electronic device, such as a central processing unit (CPU), or a system-on-chip (SoC), such as an application processor (AP). The host 108 can be configured to send or receive data to or from the memory 104.

The memory controller 106 is coupled to the memory 104 and the host 108 and is configured to control the memory 104, according to some examples. The memory controller 106 can manage the data stored in the memory 104 and communicate with the host 108. In some examples, the memory controller 106 is designed for operating in a low duty-cycle environment like secure digital (SD) cards, compact Flash (CF) cards, universal serial bus (USB) Flash drives, or other media for use in electronic devices, such as personal computers, digital cameras, mobile phones, etc. In some examples, the memory controller 106 is designed for operating in a high duty-cycle environment such as SSDs or embedded multi-media-cards (eMMCs) used as data storage for mobile devices, such as smartphones, tablets, laptop computers, etc., and enterprise storage arrays.

The memory controller 106 can be configured to control operations of the memory 104, such as read, erase, and program operations. The memory controller 106 can also be configured to manage various functions with respect to the data stored or to be stored in the memory 104 including, but not limited to bad-block management, garbage collection, logical-to-physical address conversion, wear leveling, etc. In some examples, the memory controller 106 is further configured to process error correction codes with respect to the data read from or written to the memory 104. Any other suitable functions may be performed by the memory controller 106 as well, for example, formatting the memory device 104. The memory controller 106 can communicate with an external device (e.g., the host 108 in FIG. 1) according to a particular communication protocol. For example, the memory controller 106 may communicate with the external device through at least one of various interface protocols, such as a USB protocol, an MMC protocol, a peripheral component interconnect (PCI) protocol, a peripheral component interconnect express (PCI-E) protocol, an advanced technology attachment (ATA) protocol, a serial-ATA protocol, a parallel-ATA protocol, a small computer system interface (SCSI) protocol, an enhanced small disk interface (ESDI) protocol, an integrated development equipment (IDE) protocol, a Firewire protocol, etc.

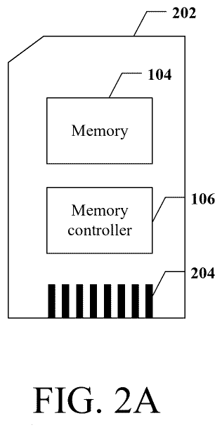

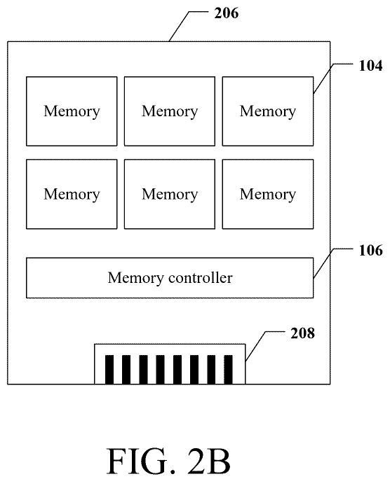

The memory controller 106 and one or more memories 104 can be integrated into various types of storage devices, for example, be included in the same package, such as a UFS package or an eMMC package. That is, the memory system 102 can be implemented and packaged into different types of end electronic products. In one example as shown in FIG. 2a, the memory controller 106 and a single memory 104 may be integrated into a memory card 202. The memory card 202 can include a PC card (personal computer memory card), a CF card, a smart media (SM) card, a memory stick, a multimedia card (MMC, Reduced-Size MMC (RS-MMC), MMCmicro), an SD card (SD, miniSD, microSD, SDHC, Reduced-Size MMC), a UFS, etc. The memory card 202 can further include a memory card connector 204 coupling the memory card 202 with a host (e.g., the host 108 in FIG. 1). In another example as shown in FIG. 2b, the memory controller 106 and multiple memories 104 may be integrated into an SSD 206. The SSD 206 can further include an SSD connector 208 coupling the SSD 206 with a host (e.g., the host 108 in FIG. 1). In some examples, at least one of the storage capacity or the operation speed of the SSD 206 is greater than those of the memory card 202.

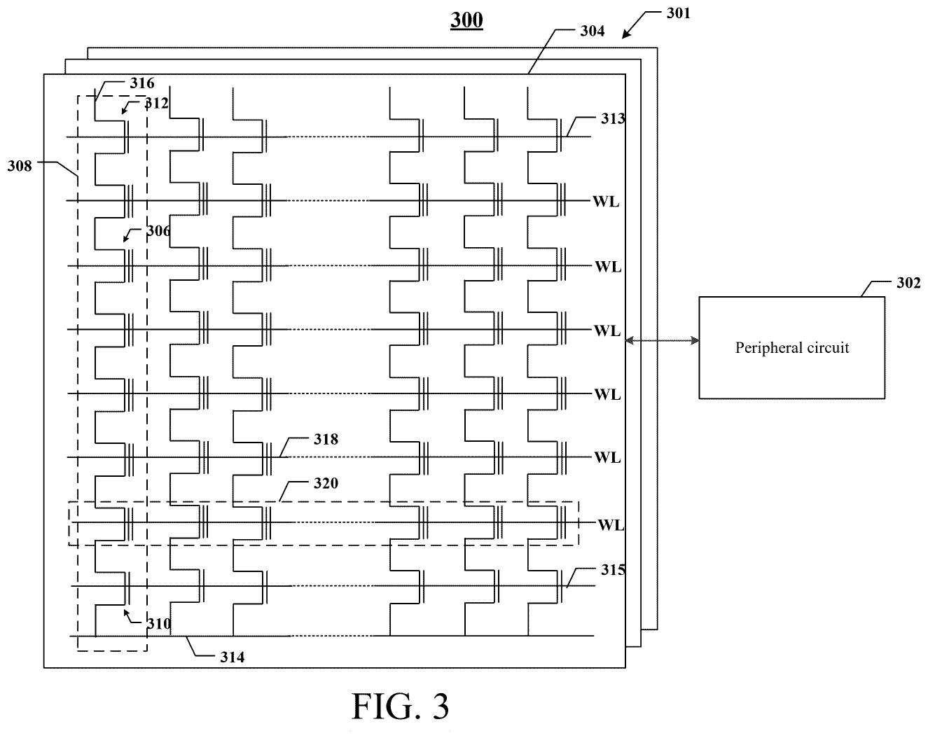

FIG. 3 is a schematic block diagram illustrating a three-dimensional NAND memory according to examples of the present disclosure. The memory 300 can be an example of the memory 104 in FIG. 1. The memory 300 can include a memory cell array 301 and a peripheral circuit 302 coupled to the memory cell array 301. The memory cell array 301 is illustrated as an example of a three-dimensional NAND memory cell array, in which memory cells 306 are provided in the form of an array of NAND memory strings 308 each extending vertically above a substrate (not shown). In some examples, each NAND memory string 308 includes a plurality of memory cells 306 coupled in series and stacked vertically. Each memory cell 306 can hold a continuous, analog value, such as an electrical voltage or charge, that depends on the number of electrons trapped within a region of the memory cells 306. Each memory cell 306 can be either a floating gate type of memory cell including a floating-gate transistor or a charge trap type of memory cell including a charge-trap transistor.

In some examples, each memory cell 306 is a single-level cell (SLC) that has two possible memory states and thus, can store one bit of data. For example, the first memory state “0” can correspond to a first range of voltages, and the second memory state “1” can correspond to a second range of voltages. In some examples, each memory cell 306 is a multi-level cell (MLC) that is capable of storing more than a single bit of data in more than four memory states. For example, the MLC can store two bits per cell, three bits per cell (also known as Trinary-Level cell (TLC)), or four bits per cell (also known as a Quad-Level cell (QLC)). Each MLC can be programmed to assume a range of possible nominal storage values. In one example, if each MLC stores two bits of data, then the MLC can be programmed to write one of three possible nominal storage values to the cell, and a fourth nominal storage value in addition to the three nominal storage values can be used to represent the erased state.

As shown in FIG. 3, each NAND memory string 308 can include a bottom select gate (BSG) 310 at its source end and a top selective gate (TSG) 312 at its drain end. BSG 310 and TSG 312 can be configured to activate selected NAND memory strings 308 during read and program operations. In some examples, the sources of NAND memory strings 308 in the same memory block 304 are coupled through the same source line (SL) 314, e.g., a common SL. In other words, all NAND memory strings 308 in the same memory block 304 have an array common source (ACS), according to some examples. TSG 312 of each NAND memory string 308 is coupled to a respective bit line (BL) 316 from which data can be read or written via an output bus (not shown), according to some examples. In some examples, each NAND memory string 308 is configured to be selected or deselected by at least one of: applying a select voltage (e.g., above the threshold voltage of the transistor having TSG 312) or a deselect voltage (e.g., 0 V) to respective TSG 312 through one or more TSG lines 313 or applying a select voltage (e.g., above the threshold voltage of the transistor having BSG 310) or a deselect voltage (e.g., 0 V) to respective BSG 310 through one or more BSG lines 315.

As shown in FIG. 3, the NAND memory strings 308 can be organized into multiple memory blocks 304, each of which can have a common source line 314, e.g., coupled to the ground. In some examples, each memory block 304 is the basic data unit for erase operations, e.g., all memory cells 306 on the same memory block 304 are erased at the same time. To erase memory cells 306 in a selected memory block, source lines coupled to the selected memory block as well as unselected memory blocks in the same plane as the selected memory block can be biased with an erase voltage (Vers), such as a high positive voltage (e.g., 20 V or more). It is understood that in some examples, the erase operation may be performed at a half-memory block level, a quarter-memory block level, or a level having any suitable number of memory blocks or any suitable fractions of a memory block. Memory cells 306 of adjacent NAND memory strings 308 can be coupled through word lines 318 that select which row of memory cells 306 is affected by read and program operations. In some examples, the memory cells 306 in the memory block 304 that are coupled to the same word line 318 may constitute at least one physical page 320. Each word line 318 may comprise a plurality of control gates (gate electrodes) at each memory cell 306 in the respective physical page 320 and a gate line coupling the control gates.

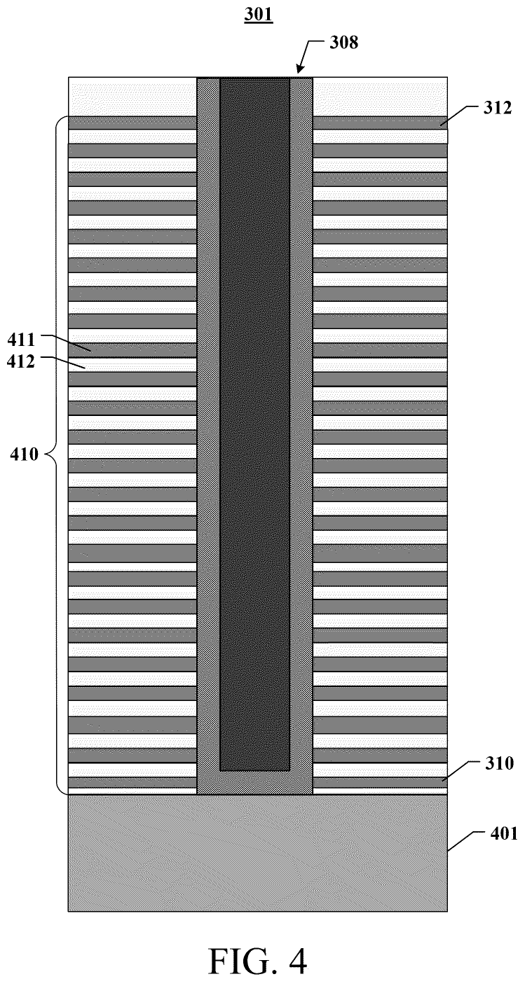

FIG. 4 is a schematic cross-sectional view illustrating a memory according to examples of the present disclosure. With reference to FIG. 4, the NAND memory string 308 may include a stacked structure 410, which includes a plurality of gate layers 411 and a plurality of insulating layers 412 alternately stacked in sequence, and a memory string 308 penetrating vertically through the gate layers 411 and the insulating layers 412. The gate layer 411 and the insulating layer 412 can be stacked alternately, and two adjacent gate layers 411 are separated by an insulating layer 412. The number of pairs of the gate layers 411 and the insulating layers 412 in the stacked structure 410 may determine the number of memory cells comprised in the memory cell array 301.

The constituent material of the gate layer 411 may include a conductive material. The conductive material may include but is not limited to tungsten (W), cobalt (Co), Copper (Cu), aluminum (Al), polysilicon, doped silicon, silicide, or any combination thereof. In some examples, each gate layer 411 includes a metal layer, e.g., a tungsten layer. In some examples, each gate layer 411 includes a doped polysilicon layer. Each gate layer 411 may include a control gate surrounding the memory cell. The gate layer 411 at the top of the stacked structure 410 may extend laterally as a top selective gate line, the gate layer 411 at the bottom of the stacked structure 410 may extend laterally as a bottom selective gate line, and the gate layer 411 extending laterally between the top selective gate line and the bottom selective gate line may be used as a word line layer.

In some examples, the stacked structure 410 may be disposed on a substrate 401. The substrate 401 may include silicon (e.g., monocrystalline silicon), silicon germanium (SiGe), gallium arsenide (GaAs), germanium (Ge), silicon-on-insulator (SOI), germanium-on-insulator (GOI), or any other suitable material.

In some examples, the NAND memory string 308 includes a channel structure extending vertically through the stacked structure 410. In some examples, the channel structure includes a channel hole filled with semiconductor material(s) (e.g., as a semiconductor channel) and dielectric material(s) (e.g., as a memory film). In some examples, the semiconductor channel includes silicon, e.g., polysilicon. In some examples, the memory film is a composite dielectric layer including a tunneling layer, a storage layer (also referred to as a “charge trap/storage layer”), and a blocking layer. The channel structure may have a cylindrical shape (e.g., a pillar shape). According to some examples, the semiconductor channel, the tunneling layer, the storage layer and the blocking layer are radially arranged in this order from the center of the pillar toward the outer surface of the pillar. The tunneling layer may include silicon oxide, silicon oxynitride, or any combination thereof. The storage layer may include silicon nitride, silicon oxynitride, or any combination thereof. The blocking layer may include silicon oxide, silicon oxynitride, a high dielectric constant (high-k) dielectric, or any combination thereof. In one example, the memory film may include a composite layer of silicon oxide/silicon oxynitride/silicon oxide (ONO).

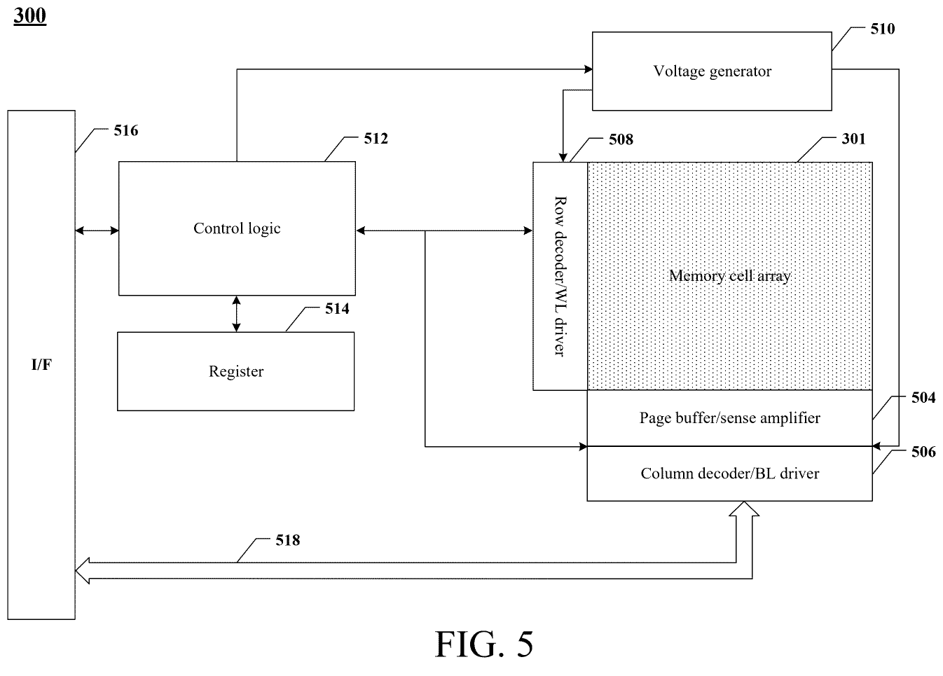

Referring back to FIG. 3, the peripheral circuit 302 can be coupled to the memory cell array 301 through bit lines 316, word lines 318, source lines 314, BSG lines 315, and TSG lines 313. The peripheral circuit 302 can include any suitable analog, digital, and mixed-signal circuits for facilitating the operations of the memory cell array 301 by applying and sensing at least one of voltage signals or current signals to and from each target memory cell 306 through bit lines 316, word lines 318, source lines 314, BSG lines 315, and TSG lines 313. The peripheral circuit 302 can include various types of peripheral circuits formed using metal-oxide-semiconductor (MOS) technologies. For example, FIG. 5 illustrates some example peripheral circuits, the peripheral circuit 302 including a page buffer/sense amplifier 504, a column decoder/bit line driver 506, a row decoder/word line driver 508, a voltage generator 510, control logic 512, registers 514, an interface 516, and a data bus 518. It is understood that in some examples, additional peripheral circuits not shown in FIG. 5 may be included as well.

The page buffer/sense amplifier 504 can be configured to read and program (write) data from and to the memory cell array 301 according to the control signals from the control logic 512. In one example, the page buffer/sense amplifier 504 may store one page of program data (write data) to be programmed into one physical page of the memory cell array 301. In another example, the page buffer/sense amplifier 504 may perform program verify operations to ensure that the data has been properly programmed into memory cells 306 coupled to selected word lines 318. In still another example, the page buffer/sense amplifier 504 may also sense the low power signals from the bit line 316 that represent data bits stored in the memory cells 306 and amplify the small voltage swing to recognizable logic levels in a read operation. The column decoder/bit line driver 506 can be configured to be controlled by the control logic 512 and select one or more NAND memory strings 308 by applying bit line voltages generated from the voltage generator 510.

The row decoder/word line driver 508 can be configured to be controlled by the control logic 512 and select/deselect memory blocks 304 of the memory cell array 301 and select/deselect word lines 318 of memory blocks 304. The row decoder/word line driver 508 can be further configured to drive word lines 318 using word line voltages generated from the voltage generator 510. In some examples, the row decoder/word line driver 508 can also select/deselect and drive BSG lines 315 and TSG lines 313 as well. As described below in detail, the row decoder/word line driver 508 is configured to perform program operations on the memory cells 306 coupled to the selected word line(s) 318. The voltage generator 510 can be configured to be controlled by the control logic 512 and generate the word line voltages (e.g., read voltage, program voltage, pass voltage, channel boost voltage, verification voltage, etc.), bit line voltages, and source line voltages to be supplied to the memory cell array 301.

The control logic 512 may be coupled to each peripheral circuit described above and configured to control the operation of each peripheral circuit. Registers 514 can be coupled to the control logic 512 and include status registers, command registers, and address registers for storing status information, command operation codes (OP codes), and command addresses for controlling the operations of each peripheral circuit. The interface 516 may be coupled to the control logic 512 and act as a control buffer to buffer and relay control commands received from a host (not shown) to the control logic 512, and to buffer and relay status information received from the control logic 512 to the host. The interface 516 may further be coupled to the column decoder/bit line driver 506 via the data bus 518 and act as a data I/O interface and data buffer to buffer and relay data to or from the memory cell array 301.

Three-dimensional NAND memory has been widely used in various memory devices as a storage medium that is more stable and faster in reading and writing data than traditional disk storage. In order to meet the increasing storage demand, the process size of the 3D NAND memory has been continuously reduced, and the type of the memory cell has been continuously evolving from SLC to MLC, TLC, and QLC, and consequently, the bit error rate of the data has been increased. The traditional BCH algorithm is no longer sufficient to ensure the reliability of the data, and the LDPC algorithm, as an error correction method whose error correction capability approaches the Shannon's limit, is gradually replacing BCH as the new generation of error correction encoding method.

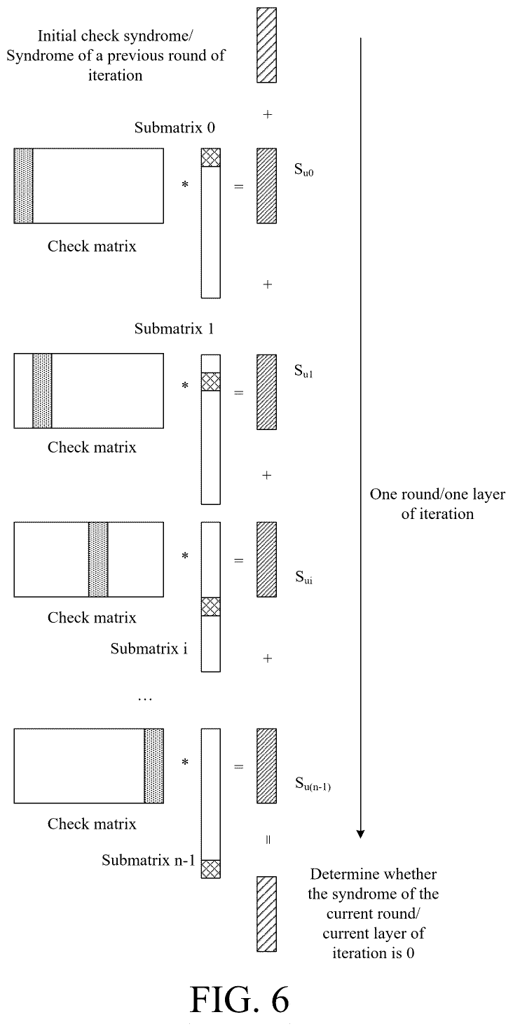

The LDPC decoding is to determine whether the decoding is successful by checking whether a syndrome is 0. In some examples, an initial check is performed on a code word using a check matrix to generate an initial check syndrome. If the initial check syndrome is 0, the decoding is successful and exited; otherwise, the code word is flipped and at least one round of iterative check is performed until the generated syndrome is 0 or the maximum number of iterations is reached. A code word typically comprises a plurality of data blocks, and each data block comprises a plurality of bits of symbols. In the process of the iterative check, a syndrome of each round of iteration is computed in an incremental way, which will be described below with reference to FIG. 6.

FIG. 6 is a schematic flow diagram illustrating an LDPC iterative check according to examples of the present disclosure. With reference to FIG. 6, if the initial check syndrome or the syndrome of the previous round of iteration is not 0, the code word is flipped to enter the current round/current layer of iterative check, and a syndrome of the current round/current layer of iteration=the initial check syndrome or the syndrome of the previous round of iteration+S_{U0}+S_{U1}+ . . . +S_{Ui}+ . . . +S_{U(n-1)}, 1≤i≤n−1, n being an integer greater than 1. If the current round/current layer of iterative check is 0, the decoding is successful and exited; otherwise, when the maximum number of iterations is not reached, the code word may be re-flipped (e.g., at least one symbol is flipped) to enter next round of iterative check. It will be appreciated that if the initial check syndrome is not 0, the current round/current layer of iterative check may be a first round/first layer of iterative check.

It is to be noted that in FIG. 6, S_{U0} is a product of a first column of the check matrix and a first submatrix 0 of the flag matrix of the current round, and S_{U1} is a product of a second column of the check matrix and a second submatrix 1 of the flag matrix of the current round, . . . , S_{Ui} is a product of an (i+1)^{th} column of the check matrix and an (i+1)^{th} submatrix i of the flag matrix of the current round, . . . , and S_{U(n-1)} is a product of an n^{th} column of the check matrix and an n^{th} submatrix n−1 of the flag matrix of the current round. Here, each submatrix in the flag matrix of the current round is to indicate whether a symbol of a corresponding data block is flipped. For example, the first submatrix 0 is to indicate whether the symbol of the first data block of the code word is flipped, . . . , and the n^{th} submatrix n−1 is to indicate whether the symbol of the n^{th} data block of the code word is flipped.

FIG. 6 illustrates computation of a syndrome of each round of iteration in the incremental way, which can reduce the complexity of the LDPC decoding to some extent, especially in a scenario where a large amount of data needs to be decoded. However, this solution needs to determine whether the decoding is successful or not after the completion of one round/one layer of iteration, which may miss a good opportunity and lead to longer decoding time and redundant error flipping.

Based on one or more of the above technical problems, examples of the present disclosure provide a decoder.

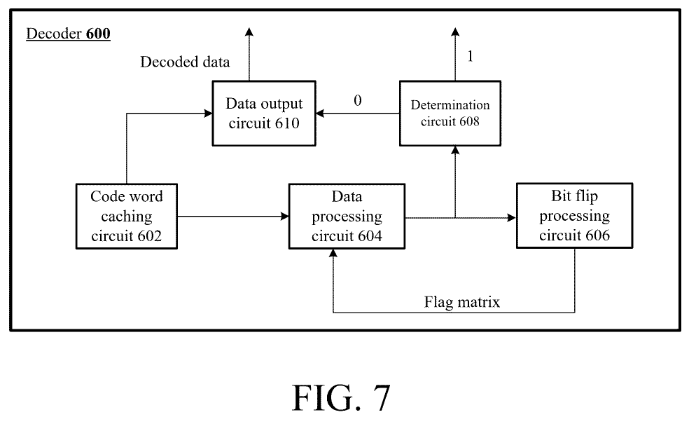

FIG. 7 is a schematic block diagram illustrating a decoder according to examples of the present disclosure. With reference to FIG. 7, the decoder 600 comprises a data processing circuit 604 and a data output circuit 610 coupled to the data processing circuit 604. The data processing circuit 604 is configured to: perform a current check computation using a current column of a check matrix and a current submatrix of a current flag matrix, wherein the check matrix comprises n columns, n being an integer greater than 1; the current flag matrix comprises n submatrices, and the current submatrix is related to a current data block of a flipped code word; the code word comprises n data blocks, and each of the data blocks comprises k bits of symbols, k being a positive integer; the current submatrix comprises k current flag bits, and each of the current flag bits is to indicate whether a corresponding symbol in the current data block of the code word is flipped; and perform a current incremental check computation on a result of the current check computation and a previous syndrome to generate a current syndrome. The data output circuit 610 is configured to: output the flipped code word based on the current syndrome meeting a check condition.

It is to be noted that, in the examples of the present disclosure, the code word includes, but is not limited to a quasi-cyclic (QC) LDPC code, and a check matrix of the quasi-cyclic (QC) LDPC code may comprise a plurality of check submatrices. Each check submatrix may be a zero matrix or a circulant permutation matrix, wherein the circulant permutation matrix may be a unit matrix or a check submatrix obtained by performing a predetermined number of cyclic shifts on the unit matrix.

In some examples, the code word comprises 512 bits of symbols and may be divided into 4 data blocks, wherein each data block comprises 128 bits of symbols. Accordingly, the current submatrix may comprise 128 current flag bits, and the 128 current flag bits of the current submatrix are to indicate whether the 128 bits of symbols of the current data block are flipped, respectively. For example, if a certain bit of the symbol of the current data block is flipped, the current flag bit corresponding to the flipped symbol in the current submatrix may be set to logic value “1”. If other symbols of the current data block are not flipped, the current flag bits corresponding to the non-flipped symbols in the current submatrix may be all set to logic value “0”. Here, the description is made by taking as an example that a value of n is 4 and a value of k is 128, which, however, does not constitute a limitation to the protection scope of the present disclosure.

It will be appreciated that the current iterative check comprises at least one incremental check computation. In the examples of the present disclosure, the current check computation may be performed using the current column of the check matrix and the current submatrix of the current flag matrix, and the current incremental check computation may be performed on the result of the current check computation and the previous syndrome to generate the current syndrome. If the current syndrome meets the check condition, it indicates that decoding is successful and the flipped code word is output. As such, decoding may be exited in time, thereby reducing decoding time and avoiding redundant error flipping.

It is to be noted that if a syndrome generated after the completion of one round of iterative check does not meet the check condition and the maximum number of iterations is not reached, the code word needs to be flipped to obtain the flipped code word, and a new round of iterative check is performed on the flipped code word. In practical application, a symbol which needs to be flipped (e.g., a wrong symbol) in the code word in one round of iterative check may be determined first, and the wrong symbol is flipped to obtain the flipped code word.

In some examples, with reference to FIG. 7, the data processing circuit 604 is further configured to: perform a next check computation using a next column of the check matrix and a next submatrix of the current flag matrix based on the current syndrome not meeting the check condition; and perform a next incremental check computation on a result of the next check computation and the current syndrome to generate a next syndrome. The data output circuit 610 is configured to: output the flipped code word based on the next syndrome meeting the check condition.

In the examples of the present disclosure, after the current incremental check computation, if the current syndrome does not meet the check condition, the next check computation may be performed using the next column of the check matrix and the next submatrix of the current flag matrix, and the next incremental check computation may be performed on the result of the next check computation and the current syndrome to generate the next syndrome. If the next syndrome meets the check condition, it indicates that the decoding is successful and the flipped code word is output. As such, decoding may be exited in time, thereby reducing decoding time and avoiding redundant error flipping.

It is to be noted that the current incremental check computation and the next incremental check computation are different stages of the current iterative check. In a case where the syndrome generated during the initial iterative check does not meet the check condition, the code word may be flipped at least once and at least one round of iterative check can be performed correspondingly. Every time when the flipped code word enters the iterative check, a flag matrix related to the flipped code word may be generated, and at least one incremental check computation may be performed using at least one column of the check matrix and at least one submatrix of the flag matrix to obtain at least one incremental syndrome. When the incremental syndrome meets the check condition, the decoding is exited in time, thereby not only reducing decoding time, but also avoiding error flipping due to redundant incremental check computations. For example, whether the decoding is successful or not is determined only after performing the incremental check computation for n times in each round of iteration in the solution illustrated in FIG. 6, which may lead to longer decoding time and may also have redundancy in the incremental check computations.

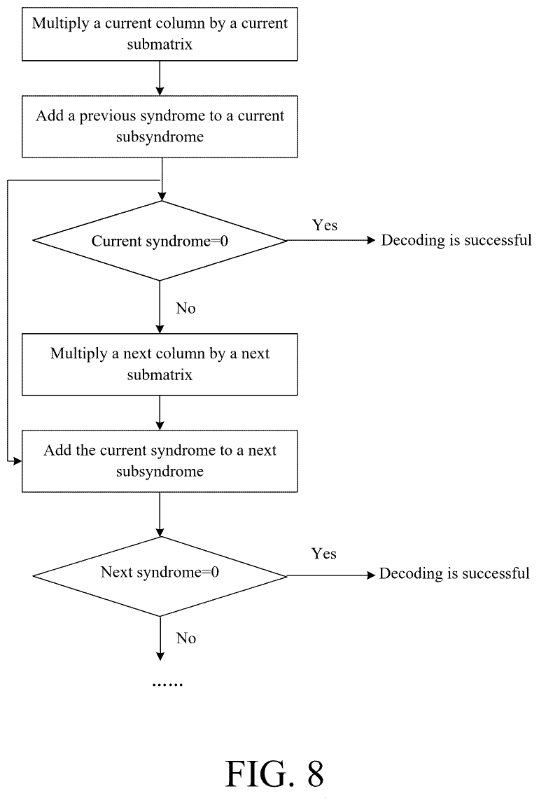

FIG. 8 is a schematic flow diagram illustrating decoding according to examples of the present disclosure. With reference to FIG. 8, a process of performing one round of iteration using the decoder 600 in the examples of the present disclosure comprises: multiplying the current column of the check matrix by the current submatrix of the current flag matrix to obtain the current subsyndrome; adding the previous syndrome to the current subsyndrome to obtain the current syndrome; if the current syndrome is 0, indicating that the decoding is successful and outputting the flipped code word; otherwise, multiplying a next column of the check matrix by a next submatrix of the current flag matrix to obtain a next subsyndrome; adding the current syndrome to the next subsyndrome to obtain a next syndrome; if the next syndrome is 0, indicating that the decoding is successful and outputting the flipped code word; otherwise, performing a similar incremental check until the obtained incremental syndrome is 0 or the current round of iteration is finished.

In the examples of the present disclosure, the check condition comprises a syndrome being 0. Meeting the check condition means that the computed initial syndrome or incremental syndrome is 0. Not meeting the check condition means that the computed initial syndrome or incremental syndrome is not 0. The following description will be made by taking as an example that the check condition is the syndrome being 0. The initial syndrome will be described in detail in the following examples, which is no longer repeated here.

In some examples, with reference to FIG. 7, the next syndrome is an n^{th} syndrome; and the decoder 600 further comprises a bit flip processing circuit 606 coupled to the data processing circuit 604 and configured to: re-flip the code word based on the n^{th} syndrome not meeting the check condition; and generate a next flag matrix related to the re-flipped code word.

In the examples of the present disclosure, if the next syndrome is the n^{th} syndrome and the n^{th} syndrome is not 0, it indicates that the current iterative check is failed and the code word needs to be re-flipped, and a next round of iterative check is performed on the re-flipped code word. Every time when the re-flipped code word enters the next round of iterative check, the next flag matrix related to the re-flipped code word may be generated, and a new round of iterative check similar to that in FIG. 8 may be performed using at least one column of the check matrix and at least one submatrix of the next flag matrix.

In some examples, a decoding operation of the code word comprises a plurality of iterative stages, wherein flag matrices corresponding to different iterative stages are different. For example, the LDPC decoding typically comprises an initial check and multiple rounds of iterative checks. After the initial check or each round of iterative check, if the generated initial syndrome or the syndrome of the current round of iterative check is not 0, the code word needs to be flipped and the flag matrix related to the flipped code word is generated. Since a position of the symbol flipped each time is different, the generated flag matrix is different. That is, the flag matrices corresponding to the different iterative stages are different.

In some examples, the data processing circuit 604 is configured to perform an initial check on the code word using the check matrix to generate an initial syndrome. The bit flip processing circuit 606 is configured to: flip the code word based on the initial syndrome not meeting the check condition; and generate a first flag matrix related to the flipped code word.

In the examples of the present disclosure, in the process of the initial check, conventional computations may be used. For example, S=HC^{T}, wherein S represents the initial syndrome; H represents the check matrix; and C represents the code word. If the initial syndrome S is not 0, a wrong symbol in the code word is flipped, and the first flag matrix related to the flipped code word is generated according to the position of the flipped wrong symbol.

In some examples, the bit flip processing circuit 606 is configured to set an initial flag bit corresponding to a flipped symbol in an initial flag matrix to a flag logic value to generate the first flag matrix or the next flag matrix.

In an example, if the initial syndrome is not 0, the wrong symbol in the code word is flipped, and the corresponding initial flag bit in the initial flag matrix is set to logic value “1” according to the position of the flipped wrong symbol. The logic value “1” is to indicate that the wrong symbol is flipped. Thus, the first flag matrix is generated.

In an example, if the n^{th} syndrome is not 0, the wrong symbol in the code word is flipped, and the corresponding initial flag bit in the initial flag matrix is set to logic value “1” according to the position of the flipped wrong symbol. The logic value “1” is to indicate that the wrong symbol is flipped. Thus, the next flag matrix is generated.

It is to be noted that the number of initial submatrices in the initial flag matrix may be equal to the number of data blocks in the code word. That is, the initial flag matrix comprises n initial submatrices. The number of initial flag bits in each initial submatrix may be equal to the number of symbols in each data block. That is, each initial submatrix comprises k initial flag bits. In some examples, the initial flag matrix may be an all-zero matrix, and the initial flag bits corresponding to non-flipped symbols in the initial flag matrix are logic value “0”.

In the examples of the present disclosure, by setting the initial flag bit corresponding to the flipped symbol in the initial flag matrix to the flag logic value, a flag matrix corresponding to each round of iteration is generated, and a check computation is performed using one column of the check matrix and one submatrix of the flag matrix. Since the number of bits of the flipped symbols in the code word is much less than the number of bits of non-flipped symbols in the code word, the logic value “1” occurs less and the logic value “0” occurs more in each submatrix of the flag matrix. As such, the complexity of the iterative check computation can be simplified and the decoding progress can be accelerated., thereby reducing the decoding time.

In some examples, the decoder 600 further comprises a code word caching circuit 602 coupled to the data processing circuit 604 and configured to cache the code word or the flipped code word. For example, in a case where an original code word to be decoded is input to the decoder 600, the code word caching circuit 602 may cache the input original code word to be decoded (e.g., the code word). For another example, in a case where the initial check is failed or one round of iterative check is failed, the code word caching circuit 602 may cache an iteratively decoded code word (e.g., the flipped code word). The data processing circuit 604 may acquire the input original code word to be decoded from the code word caching circuit 602 for performing the initial check, or acquire the iteratively decoded code word from the code word caching circuit 602 for performing the next round of iterative check.

In some examples, the data processing circuit 604 is configured to: compute a product of the current column of the check matrix and the current submatrix of the current flag matrix to generate a current subsyndrome; and perform an exclusive OR operation on the previous syndrome and the current subsyndrome to generate the current syndrome.

In the examples of the present disclosure, the data processing circuit 604 may comprise a matrix multiplier and a matrix adder, wherein the matrix multiplier is configured to compute the product of the current column of the check matrix and the current submatrix of the current flag matrix, which is achieved by an AND operation and an exclusive OR operation; and the matrix adder is configured to compute a sum of the previous syndrome and the current subsyndrome, which is achieved by the an exclusive OR operation.

In some examples, the decoder 600 further comprises a determination circuit 608 coupled to the data processing circuit 604 and the data output circuit 610 respectively and configured to determine whether the current syndrome meets the check condition.

In the examples of the present disclosure example, the determination circuit 608 may receive the current syndrome generated by the data processing circuit 604. If the current syndrome is 0, the determination circuit 608 generates a first determination result, and the data output circuit 610 outputs the flipped code word cached in the code word caching circuit 602 based on the first determination result. If the current syndrome is not 0, the determination circuit 608 generates a second determination result, the data processing circuit 604 performs a next check computation and a next incremental check computation based on the second determination result. In FIG. 7, the logic value “0” represents the first determination result, and the logic value “1” represents the second determination result. Of course, the determination circuit 608 may be further configured to determine whether the initial syndrome or other incremental syndromes (e.g., the next syndrome) is/are 0.

It is to be noted that if the initial syndrome is not 0 or the n^{th} syndrome of each round of iterative check is not 0, the bit flip processing circuit 606 flips the code word based on the second determination result.

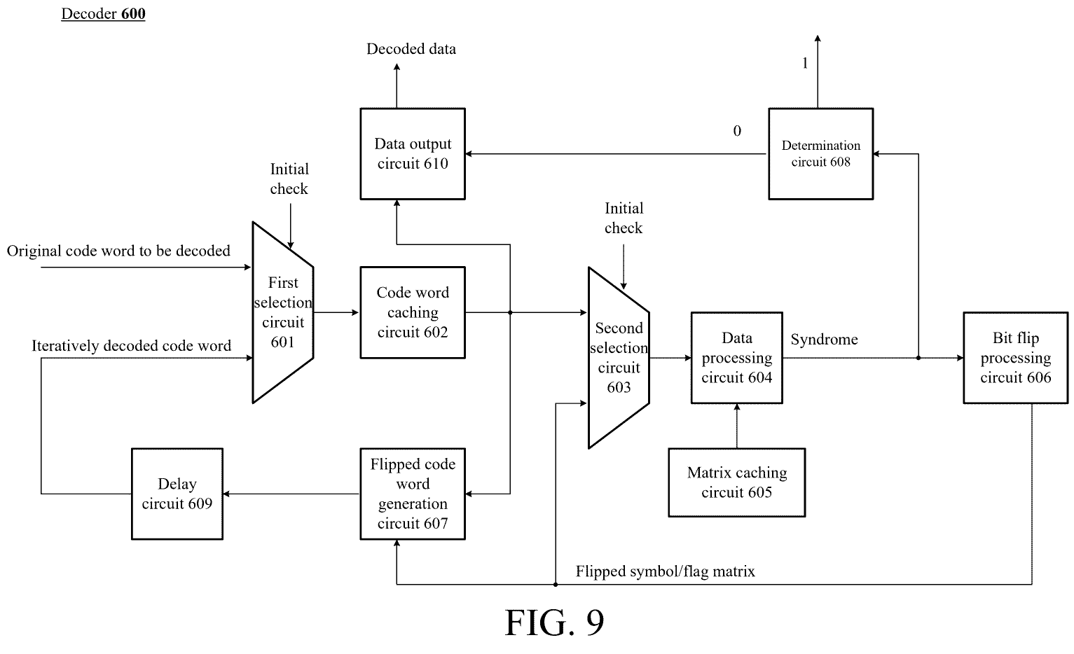

FIG. 9 is a schematic block diagram illustrating another decoder 600 according to examples of the present disclosure. In addition to the code word caching circuit 602, the data processing circuit 604, the bit flip processing circuit 606, the determination circuit 608, and the data output circuit 610 shown in FIG. 7, the decoder 600 may further comprise a first selection circuit 601, a second selection circuit 603, a matrix caching circuit 605, a flipped code word generation circuit 607, and a delay circuit 609. Of course, the decoder 600 may further comprise other circuits known in the art.

The first selection circuit 601 is configured to output the original code word to be decoded or the iteratively decoded code word based on a first control signal. In an example, if the first control signal indicates that the current check is the initial check, the first selection circuit 601 outputs the original code word to be decoded; and if the first control signal indicates that the current check is an iterative check, the first selection circuit 601 outputs the iteratively decoded code word. It will be appreciated that the iteratively decoded code word and the original code word to be decoded are different, and the iteratively decoded code word may be the flipped code word that is flipped at least once on the basis of the original code word to be decoded. The first selection circuit 601 includes, but is not limited to, a multiplexer.

The code word caching circuit 602 is coupled to the first selection circuit 601 and configured to cache the original code word to be decoded or the iteratively decoded code word. That is, the code word output by the first selection circuit 601 may be cached in the code word caching circuit 602.

The second selection circuit 603 is coupled to the code word caching circuit 602 and the bit flip processing circuit 606 respectively and configured to output the original code word to be decoded or the current submatrix of the current flag matrix based on a second control signal. In an example, if the second control signal indicates that the current check is the initial check, the second selection circuit 603 outputs the original code word to be decoded; and if the second control signal indicates that the current check is the current iterative check, the second selection circuit 603 outputs the current submatrix of the current flag matrix. The second selection circuit 603 includes, but is not limited to, a multiplexer. The following description will be made by taking as an example that the second selection circuit 603 outputs the current submatrix of the current flag matrix.

The data processing circuit 604 is coupled to the second selection circuit 603, the matrix caching circuit 605, and the bit flip processing circuit 606 respectively. The data processing circuit 604 is configured to: perform the current check computation using the current column of the check matrix and the current submatrix of the current flag matrix; and perform the current incremental check computation on the result of the current check computation and the previous syndrome to generate the current syndrome. The check matrix may be cached in the matrix caching circuit 605. Every time when the incremental check computation needs to be performed, the data processing circuit 604 may acquire one column of the check matrix from the matrix caching circuit 605. Of course, in the initial check process, the data processing circuit 604 may acquire the entire check matrix, e.g., acquire n columns of the check matrix, from the matrix caching circuit 605.

The determination circuit 608 is coupled to the data processing circuit 604, the data output circuit 610, and the bit flip processing circuit 606 respectively. The determination circuit 608 is configured to determine whether the current syndrome is 0. If the current syndrome is 0, the data output circuit 610 outputs the iteratively decoded code word cached in the code word caching circuit 602, e.g., exits decoding; otherwise, the data processing circuit 604 performs the next check computation and the next incremental check computation to generate next syndrome. This process is continued in a similar fashion until the obtained incremental syndrome is 0 or the current round of iteration is finished.

The bit flip processing circuit 606 is configured to: re-flip the code word based on the n^{th} syndrome not meeting the check condition; and generate a next flag matrix related to the re-flipped code word. Of course, the bit flip processing circuit 606 is further configured to: flip the code word based on the initial syndrome not meeting the check condition; and generate a first flag matrix related to the flipped code word.

The flipped code word generation circuit 607 is coupled to the code word caching circuit 602 and the bit flip processing circuit 606 respectively. The flipped code word generation circuit 607 is configured to generate a next iteratively decoded code word based on the flipped symbol and the code word cached in the code word caching circuit 602. In an example, the flipped code word generation circuit 607 includes, but is not limited to, an exclusive OR logic gate circuit.

The delay circuit 609 is coupled to the flipped code word generation circuit 607 and the first selection circuit 601 respectively. The delay circuit 609 is configured to delay the next iteratively decoded code word for a preset duration. It is to be noted that the computation of the data processing circuit 604 and the determination circuit 608 is time-consuming, and if the next iteratively decoded code word is immediately input to the first selection circuit 601, redundant data will be written back to the code word caching circuit 602, which might cause unexpected decoding errors. Therefore, by delaying the next iteratively decoded code word for the preset duration, data write-back can be avoided. Here, the preset duration may be reasonably set according to a computation delay of the data processing circuit 604, which will not be particularly limited in the present disclosure.

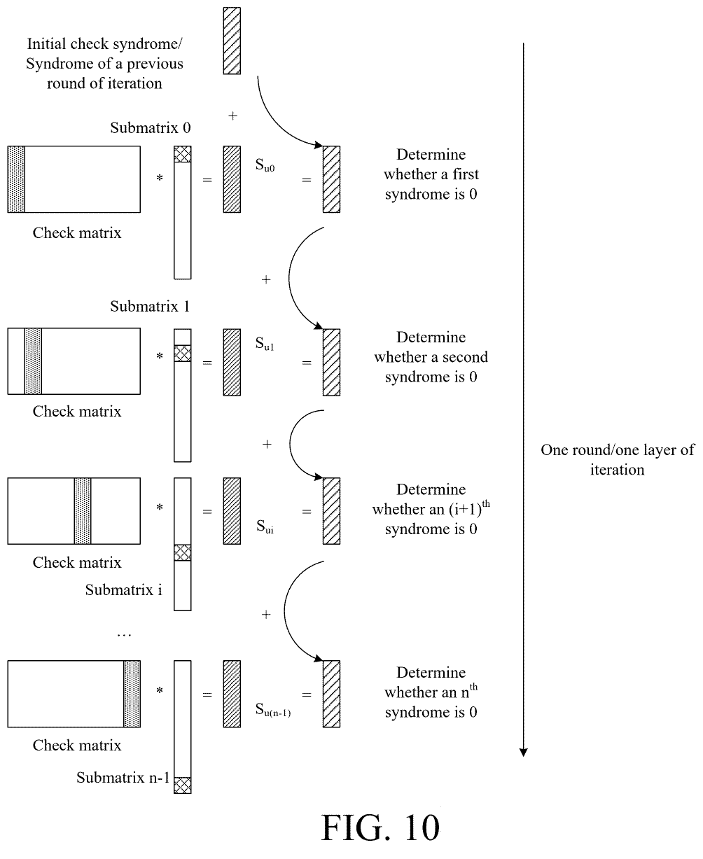

FIG. 10 is a schematic flow diagram illustrating another LDPC iterative decoding according to examples of the present disclosure. A process of the decoder provided in the examples of the present disclosure performing one round of iteration will be described as an example below with reference to FIG. 10.

In the process of one round of iteration, a first check computation is performed using a first column of the check matrix and a first submatrix 0 of the current flag matrix to generate a first subsyndrome S_{U0}, and a first incremental check computation is performed on the first subsyndrome S_{U0} and the initial check syndrome or the syndrome of the previous round of iteration to generate a first syndrome. Whether the first syndrome is 0 is determined. If the first syndrome is 0, the decoding is successful and exited.

If the first syndrome is not 0, a second check computation is performed using a second column of the check matrix and a second submatrix 1 of the current flag matrix to generate a second subsyndrome S_{U1}, and a second incremental check computation is performed on the second subsyndrome S_{U1} and the first syndrome to generate a second syndrome. Whether the second syndrome is 0 is determined. If the second syndrome is 0, the decoding is successful and exited. This process is continued in a similar fashion until the obtained incremental syndrome (e.g., the (i+1)^{th} syndrome) is 0, or if the n^{th} syndrome is still not 0 when the current round of iteration is finished, the code word is flipped to enter the next round of iteration.

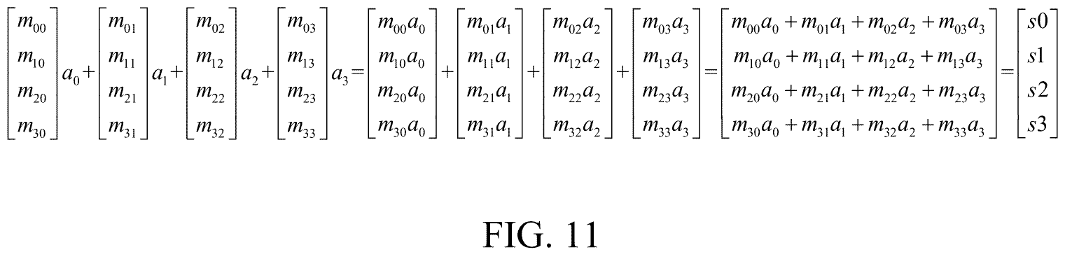

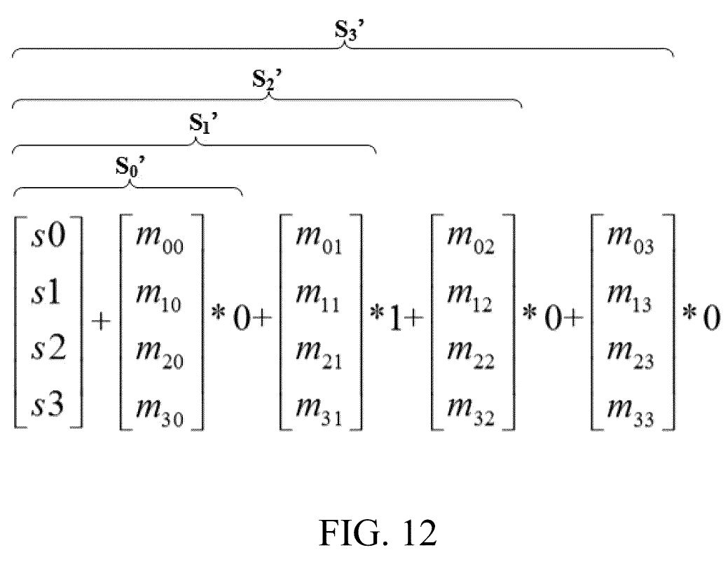

FIG. 11 is a schematic diagram illustrating calculation of an initial syndrome according to examples of the present disclosure, and FIG. 12 is a schematic diagram illustrating computation of an incremental syndrome according to examples of the present disclosure. The LDPC decoding provided in the examples of the present disclosure will be described as an example below with reference to FIG. 11 and FIG. 12.

With reference to FIG. 11, an initial check is performed on a code word using a check matrix to generate an initial syndrome, wherein the check matrix is a matrix of 4 rows*4 columns; the code word comprises 4 data blocks which are represented as a₀, a₁, a₂, and a₃, respectively; and the initial syndrome comprises 4 check formulas which are represented as s0, s1, s2, and s3, respectively. If the 4 check formulas are all 0, the decoding is successful and exited. If at least one of the 4 check formulas is not 0, at least one symbol in at least one data block of the code word is flipped, and a first flag matrix related to the flipped code word is generated for proceeding into a first round of iterative check. For example, the symbol in a second data block of the code word is flipped, and the first flag matrix comprises 4 submatrices which are represented as 0, 1, 0, and 0, respectively.

With reference to FIG. 12, a product of a first column of the check matrix and a first submatrix 0 is computed, and a first incremental check computation is performed on the product and the initial syndrome to generate a first syndrome S₀′. Whether the first syndrome S₀′ is 0 is determined. If the first syndrome S₀′ is 0, the decoding is successful and exited.

If the first syndrome S₀′ is not 0, a product of a second column of the check matrix and a second submatrix 1 is computed, and a second incremental check computation is performed on the product and the first syndrome S₀′ to generate a second syndrome S₁′. Whether the second syndrome S₁′ is 0 is determined. If the second syndrome S₁′ is 0, the decoding is successful and exited.

If the second syndrome S₁′ is not 0, a product of a third column of the check matrix and a third submatrix 0 is computed, and a third incremental check computation is performed on the product and the second syndrome S₁′ to generate a third syndrome S₂′. Whether the third syndrome S₂′ is 0 is determined. If the third syndrome S₂′ is 0, the decoding is successful and exited.

If the third syndrome S₂′ is not 0, a product of a fourth column of the check matrix and a fourth submatrix 0 is computed, and a fourth incremental check computation is performed on the product and the third syndrome S₂′ to generate a fourth syndrome S₃′. Whether the fourth syndrome S₃′ is 0 is determined. If the fourth syndrome S₃′ is 0, the decoding is successful and exited.

If the fourth syndrome S₃′ is not 0, at least one symbol in at least one data block of the code word is re-flipped, and a second flag matrix related to the re-flipped code word is generated for proceeding into a second round of iterative check. For the second round of iterative check, a reference may be made to the related description in the above examples, which is no longer repeated here for simplicity.

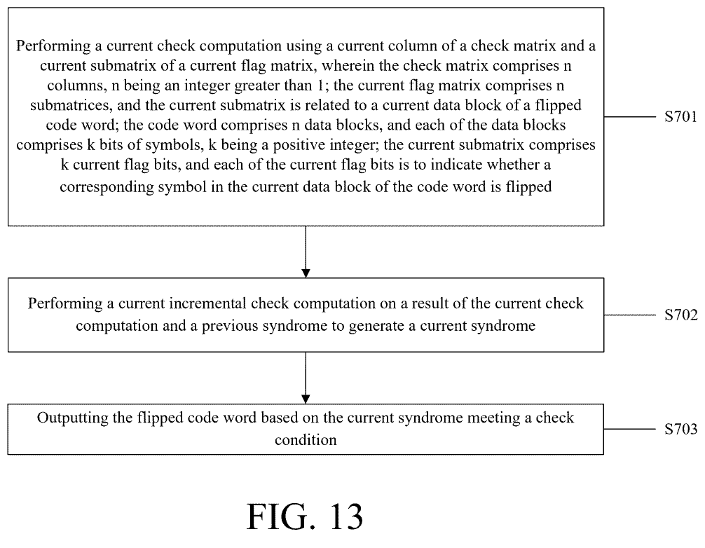

Based on the above-mentioned decoder, examples of the present disclosure provide a decoding method. FIG. 13 is a flow diagram illustrating a decoding method according to examples of the present disclosure. With reference to FIG. 13, the decoding method comprises:

S701: performing a current check computation using a current column of a check matrix and a current submatrix of a current flag matrix, wherein the check matrix comprises n columns, n being an integer greater than 1; the current flag matrix comprises n submatrices, and the current submatrix is related to a current data block of a flipped code word; the code word comprises n data blocks, and each of the data blocks comprises k bits of symbols, k being a positive integer; the current submatrix comprises k current flag bits, and each of the current flag bits is to indicate whether a corresponding symbol in the current data block of the code word is flipped;

S702: performing a current incremental check computation on a result of the current check computation and a previous syndrome to generate a current syndrome; and S703: outputting the flipped code word based on the current syndrome meeting a check condition.

In some examples, the decoding method further comprise: performing a next check computation using a next column of the check matrix and a next submatrix of the current flag matrix based on the current syndrome not meeting the check condition; performing a next incremental check computation on a result of the next check computation and the current syndrome to generate a next syndrome; and outputting the flipped code word based on the next syndrome meeting the check condition.

In some examples, the next syndrome is an n^{th} syndrome, and the decoding method further comprises: re-flipping the code word based on the n^{th} syndrome not meeting the check condition; and generating a next flag matrix related to the re-flipped code word.

In some examples, the decoding method further comprises: performing an initial check on the code word using the check matrix to generate an initial syndrome; flipping the code word based on the initial syndrome not meeting the check condition; and generating a first flag matrix related to the flipped code word.

In some examples, the generating the first flag matrix or the next flag matrix related to the flipped code word comprises: setting an initial flag bit corresponding to a flipped symbol in an initial flag matrix to a flag logic value to generate the first flag matrix or the next flag matrix.

In some examples, the decoding method further comprises: caching the code word or the flipped code word.

In some examples, the S701 comprises: computing a product of the current column of the check matrix and the current submatrix of the current flag matrix to generate a current subsyndrome; and S702 comprises: performing an exclusive OR operation on the previous syndrome and the current subsyndrome to generate the current syndrome.

In some examples, the decoding method further comprises: determining whether the current syndrome meets the check condition.

In some examples, the check condition comprises a syndrome being 0.

In the examples of the present disclosure, the decoding method may be performed by the decoder as described in any of the above examples, and the technical effects that can be realized by the decoder in the above examples all can be realized by this decoding method, which are no longer repeated one by one here. Examples of each operation of the decoding method in the above examples are described in detail in relevant decoder examples, which is no longer set forth in detail here.

Based on the above-mentioned decoder, examples of the present disclosure further provide a memory system. The memory system comprises a memory and a decoder coupled to the memory. The memory is configured to output read data. The decoder is configured to perform a decoding operation on a code word converted from the read data.

In some examples, the memory system further comprises an encoder. The encoder is configured to receive write data and perform an encoding operation on the write data. The memory is further configured to receive the encoded write data.

Based on the above-mentioned decoder, examples of the present disclosure further provide a memory controller comprising:
a memory interface configured to receive read data; and
a decoder coupled to the memory interface and configured to perform a decoding operation on a code word converted from the read data.

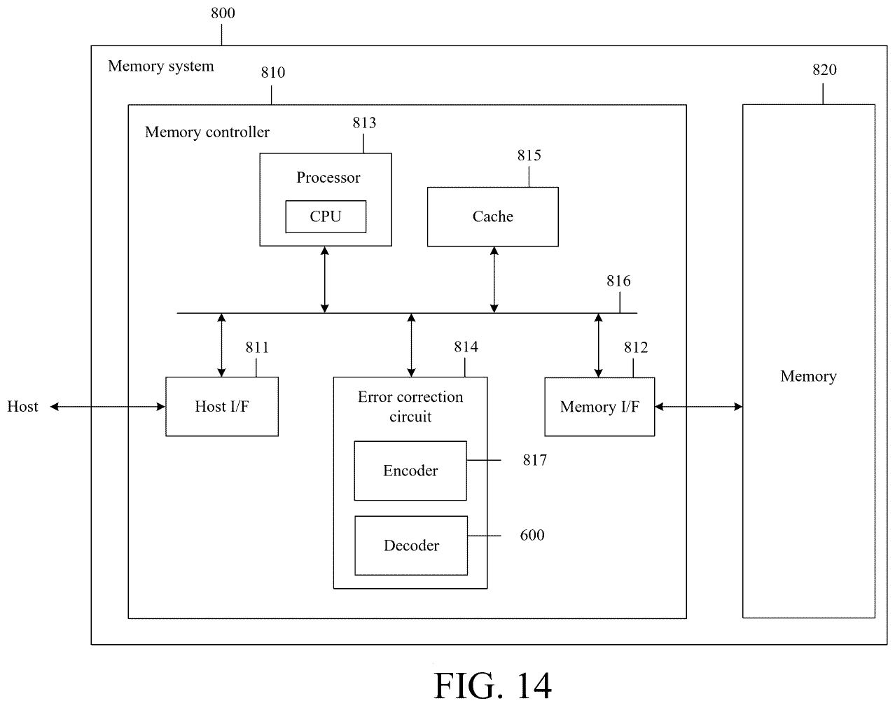

FIG. 14 is a schematic block diagram illustrating a memory system according to examples of the present disclosure. The memory system and the memory controller provided in the examples of the present disclosure will be described as an example below with reference to FIG. 14.

With reference to FIG. 14, the memory system 800 comprises a memory controller 810 and a memory 820. The memory controller 810 is configured to control the memory 820 to perform read and write operations. Here, the memory controller 810 may be coupled with the memory 820 in any suitable manner. The memory controller 810 comprises a processor (CPU) 813, a cache 815, an error correction circuit 814, a host I/F 811, and a memory I/F 812. In the examples of the present disclosure, the memory 820 may comprise a semiconductor memory storing data in a non-volatile manner, such as, a NAND memory. The memory system 800 is connected with a host. The host I/F 811 outputs a command and valid data (write data), etc. received from the host to an internal bus 816, and sends the valid data (read data) read from the memory 820 and a response from the processor 813, etc. to the host.

The processor 813 may indicate to the memory I/F 812 according to a command from the host to write the valid data and parity check data as well as a check matrix to the memory 820. Moreover, the control unit may indicate to the memory I/F 812 according to a command from the host to read the valid data and the parity check data as well as the check matrix from the memory.

Here, the error correction circuit 814 comprises an encoder 817 and the above-mentioned decoder 600. The encoder 817 encodes the written valid data of a predetermined size to generate the parity check data (e.g., a Low Density Parity Check Code (LDPC)) and the corresponding check matrix. The parity check data and the corresponding check matrix generated by the encoder 817 may be stored in the memory. The decoder 600 uses the parity check data and the corresponding check matrix for decoding. The decoder 600 mentioned here comprises a coder, and the parity check data and the corresponding check matrix used during coding may be acquired from the memory.

Based on the above-mentioned decoder, examples of the present disclosure further provide a computer readable storage medium having instructions stored thereon which, when executed by a processor, implement the decoding method of any of the above examples.

Here, the associated hardware may be instructed by instructions to achieve all or part of processes in the decoding method of the above examples. The instructions may be stored in a computer readable storage medium, and when executed, may implement the processes of the above method examples. The storage medium may comprise a Ferromagnetic Random Access Memory (FRAM), a Read Only Memory (ROM), a Programmable Read-Only Memory (PROM), an Erasable Programmable Read-Only Memory (EPROM), an Electrically Erasable Programmable Read-Only Memory (EEPROM), a Flash Memory, a magnetic surface memory, an optical disk, or a Compact Disc Read-Only Memory (CD-ROM), etc.; the storage medium may further comprise a combination of the above memories.

The features disclosed in several device examples provided by the present disclosure may be combined arbitrarily to obtain a new device example in case of no conflicts.

The methods disclosed in several method examples provided by the present disclosure may be combined arbitrarily to obtain a new method example in case of no conflicts.

According to a first aspect of examples of the present disclosure, there is provided a decoder comprising a data processing circuit and a data output circuit coupled to the data processing circuit; wherein the data processing circuit is configured to: perform a current check computation using a current column of a check matrix and a current submatrix of a current flag matrix, wherein the check matrix comprises n columns, n being an integer greater than 1; the current flag matrix comprises n submatrices, and the current submatrix is related to a current data block of a flipped code word; the code word comprises n data blocks, and each of the data blocks comprises k bits of symbols, k being a positive integer; the current submatrix comprises k current flag bits, and each of the current flag bits is to indicate whether a corresponding symbol in the current data block of the code word is flipped; and perform a current incremental check computation on a result of the current check computation and a previous syndrome to generate a current syndrome; and the data output circuit is configured to: output the flipped code word based on the current syndrome meeting a check condition.

In some examples, the data processing circuit is further configured to: perform a next check computation using a next column of the check matrix and a next submatrix of the current flag matrix based on the current syndrome not meeting the check condition; and perform a next incremental check computation on a result of the next check computation and the current syndrome to generate a next syndrome; and the data output circuit is configured to: output the flipped code word based on the next syndrome meeting the check condition.

In some examples, the next syndrome is an n^{th} syndrome, and the decoder further comprises: a bit flip processing circuit coupled to the data processing circuit and configured to: re-flip the code word based on the n^{th} syndrome not meeting the check condition; and generate a next flag matrix related to the re-flipped code word.

In some examples, the data processing circuit is configured to: perform an initial check on the code word using the check matrix to generate an initial syndrome; and the bit flip processing circuit is configured to: flip the code word based on the initial syndrome not meeting the check condition; and generate a first flag matrix related to the flipped code word.

In some examples, the bit flip processing circuit is configured to: set an initial flag bit corresponding to a flipped symbol in an initial flag matrix to a flag logic value to generate the first flag matrix or the next flag matrix.

In some examples, a decoding operation of the code word comprises a plurality of iterative stages, wherein flag matrices corresponding to different iterative stages are different.

In some examples, the decoder further comprises a code word caching circuit coupled to the data processing circuit and configured to: cache the code word or the flipped code word.

In some examples, the data processing circuit is configured to: compute a product of the current column of the check matrix and the current submatrix of the current flag matrix to generate a current subsyndrome; and perform an exclusive OR operation on the previous syndrome and the current subsyndrome to generate the current syndrome.

In some examples, the decoder further comprises a determination circuit coupled to the data processing circuit and the data output circuit respectively and configured to: determine whether the current syndrome meets the check condition.

In some examples, the check condition comprises a syndrome being 0.

According to a second aspect of examples of the present disclosure, there is provided a decoding method, comprising: performing a current check computation using a current column of a check matrix and a current submatrix of a current flag matrix, wherein the check matrix comprises n columns, n being an integer greater than 1; the current flag matrix comprises n submatrices, and the current submatrix is related to a current data block of a flipped code word; the code word comprises n data blocks, and each of the data blocks comprises k bits of symbols, k being a positive integer; the current submatrix comprises k current flag bits, and each of the current flag bits is to indicate whether a corresponding symbol in the current data block of the code word is flipped;

performing a current incremental check computation on a result of the current check computation and a previous syndrome to generate a current syndrome; and outputting the flipped code word based on the current syndrome meeting a check condition.

In some examples, the decoding method further comprises: performing a next check computation using a next column of the check matrix and a next submatrix of the current flag matrix based on the current syndrome not meeting the check condition; performing a next incremental check computation on a result of the next check computation and the current syndrome to generate a next syndrome; and outputting the flipped code word based on the next syndrome meeting the check condition.

In some examples, the next syndrome is an n^{th} syndrome, and the decoding method further comprises: re-flipping the code word based on the n^{th} syndrome not meeting the check condition; and generating a next flag matrix related to the re-flipped code word.

In some examples, the decoding method further comprises: performing an initial check on the code word using the check matrix to generate an initial syndrome; flipping the code word based on the initial syndrome not meeting the check condition; and generating a first flag matrix related to the flipped code word.

In some examples, the generating the first flag matrix or the next flag matrix related to the flipped code word comprises: setting an initial flag bit corresponding to a flipped symbol in an initial flag matrix to a flag logic value to generate the first flag matrix or the next flag matrix.

In some examples, the decoding method further comprises: caching the code word or the flipped code word.

In some examples, the performing a current check computation using a current column of a check matrix and a current submatrix of a current flag matrix comprises: computing a product of the current column of the check matrix and the current submatrix of the current flag matrix to generate a current subsyndrome; and the performing a current incremental check computation on a result of the current check computation and a previous syndrome comprises: performing an exclusive OR operation on the previous syndrome and the current subsyndrome to generate the current syndrome.

In some examples, the decoding method further comprises: determining whether the current syndrome meets the check condition.

In some examples, the check condition comprises a syndrome being 0.

According to a third aspect of examples of the present disclosure, it is provided a memory system comprising: a memory configured to output read data; and the decoder according to any one of the examples in the first aspect of the examples of the present disclosure, wherein the decoder is coupled to the memory and configured to perform a decoding operation on a code word converted from the read data.

In some examples, the memory system further comprises: an encoder configured to receive write data and perform an encoding operation on the write data; wherein the memory is further configured to receive the encoded write data.

According to a fourth aspect of examples of the present disclosure, there is provided a memory controller comprising: a memory interface configured to receive read data; and the decoder of any one of the examples in the first aspect of the examples of the present disclosure, wherein the decoder is coupled to the memory interface and configured to perform a decoding operation on a code word converted from the read data.

According to a fifth aspect of examples of the present disclosure, there is provided a computer readable storage medium having instructions stored thereon which, when executed by a processor, implement the decoding method of any one of the examples in the second aspect of examples of the present disclosure.

In the examples of the present disclosure, the current check computation may be performed using the current column of the check matrix and the current submatrix of the current flag matrix, and the current incremental check computation may be performed on the result of the current check computation and the previous syndrome to generate the current syndrome. If the current syndrome meets the check condition, it indicates that decoding is successful and the flipped code word is output. As such, decoding may be exited in time, thereby reducing decoding time and avoiding redundant error flipping.

The above descriptions are merely specific examples of the present disclosure, and the protection scope of the present disclosure is not limited thereto. Any variation or replacement that may be readily figured out by those skilled in the art within the technical scope disclosed by the present disclosure shall fall within the protection scope of the present disclosure.

What is claimed is:

1. A decoder, comprising:
a data processing circuit configured to:
perform a current check computation using a current column of a check matrix and a current submatrix of a current flag matrix, wherein the check matrix includes n columns, n being an integer greater than 1; the current flag matrix includes n submatrices, and the current submatrix is related to a current data block of a flipped code word; the code word includes n data blocks, and each of the data blocks includes k bits of symbols, k being a positive integer; the current submatrix includes k current flag bits, and each of the current flag bits is to indicate whether a corresponding symbol in the current data block of the code word is flipped; and
perform a current incremental check computation on a result of the current check computation and a previous syndrome to generate a current syndrome; and
a data output circuit coupled to the data processing circuit and configured to:
output the flipped code word based on the current syndrome meeting a check condition.

2. The decoder of claim 1, wherein
the data processing circuit is further configured to:
perform a next check computation using a next column of the check matrix and a next submatrix of the current flag matrix based on the current syndrome not meeting the check condition; and
perform a next incremental check computation on a result of the next check computation and the current syndrome to generate a next syndrome; and
the data output circuit is configured to:
output the flipped code word based on the next syndrome meeting the check condition.

3. The decoder of claim 2, wherein the next syndrome is an n^{th} syndrome, and the decoder further includes:
a bit flip processing circuit coupled to the data processing circuit and configured to:
re-flip the code word based on the n^{th} syndrome not meeting the check condition; and
generate a next flag matrix related to the re-flipped code word.

4. The decoder of claim 3, wherein
the data processing circuit is configured to:
perform an initial check on the code word using the check matrix to generate an initial syndrome; and
the bit flip processing circuit is configured to:
flip the code word based on the initial syndrome not meeting the check condition; and
generate a first flag matrix related to the flipped code word.

5. The decoder of claim 3, wherein the bit flip processing circuit is configured to:
set an initial flag bit corresponding to a flipped symbol in an initial flag matrix to a flag logic value to generate the first flag matrix or the next flag matrix.

6. The decoder of claim 5, wherein a decoding operation of the code word includes a plurality of iterative stages, and wherein flag matrices corresponding to different iterative stages are different.

7. The decoder of claim 3, further including:
a code word caching circuit coupled to the data processing circuit and configured to:
cache the code word or the flipped code word.

8. The decoder of claim 1, wherein the data processing circuit is configured to:
compute a product of the current column of the check matrix and the current submatrix of the current flag matrix to generate a current subsyndrome; and
perform an exclusive OR operation on the previous syndrome and the current subsyndrome to generate the current syndrome.

9. The decoder of claim 1, further including:
a determination circuit coupled to the data processing circuit and the data output circuit respectively and configured to:
determine whether the current syndrome meets the check condition.

10. The decoder of claim 1, wherein the check condition includes a syndrome being 0.

11. A decoding method, comprising:
performing a current check computation using a current column of a check matrix and a current submatrix of a current flag matrix, wherein the check matrix includes n columns, n being an integer greater than 1; the current flag matrix includes n submatrices, and the current submatrix is related to a current data block of a flipped code word; the code word includes n data blocks, and each of the data blocks includes k bits of symbols, k being a positive integer; the current submatrix includes k current flag bits, and each of the current flag bits is to indicate whether a corresponding symbol in the current data block of the code word is flipped;
performing a current incremental check computation on a result of the current check computation and a previous syndrome to generate a current syndrome; and
outputting the flipped code word based on the current syndrome meeting a check condition.

12. The decoding method of claim 11, further including:
performing a next check computation using a next column of the check matrix and a next submatrix of the current flag matrix based on the current syndrome not meeting the check condition;
performing a next incremental check computation on a result of the next check computation and the current syndrome to generate a next syndrome; and
outputting the flipped code word based on the next syndrome meeting the check condition.

13. The decoding method of claim 12, wherein the next syndrome is an n^{th} syndrome, and the decoding method further includes:
re-flipping the code word based on the n^{th} syndrome not meeting the check condition; and
generating a next flag matrix related to the re-flipped code word.

14. The decoding method of claim 12, further including:
performing an initial check on the code word using the check matrix to generate an initial syndrome;
flipping the code word based on the initial syndrome not meeting the check condition; and
generating a first flag matrix related to the flipped code word.

15. The decoding method of claim 13, wherein the generating the first flag matrix or the next flag matrix related to the flipped code word includes:
setting an initial flag bit corresponding to a flipped symbol in an initial flag matrix to a flag logic value to generate the first flag matrix or the next flag matrix.

16. The decoding method of claim 14, further including:
caching the code word or the flipped code word.

17. The decoding method of claim 11, wherein
the performing a current check computation using a current column of a check matrix and a current submatrix of a current flag matrix includes:
computing a product of the current column of the check matrix and the current submatrix of the current flag matrix to generate a current subsyndrome; and
the performing a current incremental check computation on a result of the current check computation and a previous syndrome includes:
performing an exclusive OR operation on the previous syndrome and the current subsyndrome to generate the current syndrome.

18. The decoding method of claim 11, further including:
determining whether the current syndrome meets the check condition.

19. A memory system, comprising:
a memory configured to output read data; and
a decoder coupled to the memory and configured to perform a decoding operation on a code word converted from the read data, wherein the decoder includes:
a data processing circuit configured to:
perform a current check computation using a current column of a check matrix and a current submatrix of a current flag matrix, wherein the check matrix includes n columns, n being an integer greater than 1; the current flag matrix includes n submatrices, and the current submatrix is related to a current data block of a flipped code word; the code word includes n data blocks, and each of the data blocks includes k bits of symbols, k being a positive integer; the current submatrix includes k current flag bits, and each of the current flag bits is to indicate whether a corresponding symbol in the current data block of the code word is flipped; and
perform a current incremental check computation on a result of the current check computation and a previous syndrome to generate a current syndrome; and
a data output circuit coupled to the data processing circuit and configured to:
output the flipped code word based on the current syndrome meeting a check condition.

20. The memory system of claim 19, further including:
an encoder configured to receive write data and perform an encoding operation on the write data, and
wherein the memory is further configured to receive the encoded write data.
